(19) United States
(12) Patent Application Publication
(10) Pub. No.: US 2024/0212012 A1
(43) Pub. Date: Jun. 27, 2024

(54) REIMBURSEMENT CODE-BASED DATA PROCESSING METHOD AND DEVICE

(71) Applicant: Alipay (Hangzhou) Information Technology Co., Ltd., Hangzhou (CN)

(72) Inventors: Yue Wang, Hangzhou (CN); Kun Wu, Hangzhou (CN); Haitao Shen, Hangzhou (CN); Jianhui Hua, Hangzhou (CN)

(21) Appl. No.: 18/555,835

(22) PCT Filed: Apr. 13, 2022
(86) PCT No.: PCT/CN2022/086513

§ 371 Date: Oct. 17, 2023

(30) Foreign Application Priority Data
Apr. 20, 2021 (CN) 202110426908.9

(51) Int. Cl. G06Q 30/04

(52) U.S. Cl. CPC G06Q 30/04

(57) ABSTRACT

Embodiments of this specification provide a reimbursement code-based data processing method and apparatus. A reimbursement code-based data processing method includes: performing expense control verification on a target order of an institution member based on an expense control rule configured in a reimbursement code of an institution; paying, if expense control verification succeeds, for the target order based on an institution account bound to the institution, to obtain bill information; transferring the bill information to a ticket application link activated by an order participant, to generate an electronic ticket of the target order; and creating a reimbursement form of the institution member based on the electronic ticket and the bill information.

### TECHNICAL FIELD

This document relates to the field of data processing technologies, and in particular, to a reimbursement code-based data processing method and apparatus.

### BACKGROUND

With development of Internet technologies, an electronic ticket is widely applied. Like an ordinary paper ticket, the electronic ticket has a code issued by a tax institution. Therefore, the electronic ticket has the same credential effect as the ordinary paper ticket, but the electronic ticket is more convenient than the ordinary paper ticket in aspects such as ticket issuance and reimbursement. In a process of reimbursing expense by using a ticket, it is necessary to fill in an electronic form such as a reimbursement application form, and then the reimbursement application form for which filling is completed is submitted to a reviewer for review. After review succeeds, the ticket is reimbursed. A reimbursement process is cumbersome. In the reimbursement process, a ticket item type filling error, or the like usually occurs. A person who applies for ticket reimbursement and a reviewer both need to spend much time and energy.

### SUMMARY

One or more embodiments of this specification provide a reimbursement code-based data processing method. The reimbursement code-based data processing method includes: performing expense control verification on a target order of an institution member based on an expense control rule configured in a reimbursement code of an institution; paying, if expense control verification succeeds, for the target order based on an institution account bound to the institution, to obtain bill information: transferring the bill information to a ticket application link activated by an order participant, to generate an electronic ticket of the target order; and creating a reimbursement form of the institution member based on the electronic ticket and the bill information.

One or more embodiments of this specification provide a reimbursement code-based data processing apparatus, including: an expense control verification module, configured to perform expense control verification on a target order of an institution member based on an expense control rule configured in a reimbursement code of an institution: an order payment module, configured to pay, if expense control verification succeeds, for the target order based on an institution account bound to the institution, to obtain bill information; an electronic ticket generation module, configured to transfer the bill information to a ticket application link activated by an order participant, to generate an electronic ticket of the target order; and a reimbursement form creation module, configured to create a reimbursement form of the institution member based on the electronic ticket and the bill information.

One or more embodiments of this specification provide a reimbursement code-based data processing device, including a processor; and a storage configured to store computer-executable instructions, where when the computer-executable instructions are executed, the processor is enabled to perform the following operations: performing expense control verification on a target order of an institution member based on an expense control rule configured in a reimbursement code of an institution: paying, if expense control verification succeeds, for the target order based on an institution account bound to the institution, to obtain bill information: transferring the bill information to a ticket application link activated by an order participant, to generate an electronic ticket of the target order: and creating a reimbursement form of the institution member based on the electronic ticket and the bill information.

One or more embodiments of this specification provide a first storage medium, configured to store computer-executable instructions, where when the computer-executable instructions are executed, the following procedure is implemented: performing expense control verification on a target order of an institution member based on an expense control rule configured in a reimbursement code of an institution; paying, if expense control verification succeeds, for the target order based on an institution account bound to the institution, to obtain bill information: transferring the bill information to a ticket application link activated by an order participant, to generate an electronic ticket of the target order; and creating a reimbursement form of the institution member based on the electronic ticket and the bill information.

### BRIEF DESCRIPTION OF DRAWINGS

To describe the technical solutions in one or more embodiments of this specification or in the existing technology more clearly, the following briefly describes the accompanying drawings for describing the embodiments or the existing technology. Clearly, the accompanying drawings in the following description merely show some embodiments of this specification, and a person of ordinary skill in the art can still derive other drawings from these accompanying drawings without creative efforts.

FIG. 1 is a flowchart of processing of a reimbursement code-based data processing method according to one or more embodiments of this specification:

FIG. 2 is a flowchart of processing of a reimbursement code-based data processing method applied to an enterprise reimbursement scenario according to one or more embodiments of this specification:

FIG. 3 is a flowchart of processing of another reimbursement code-based data processing method applied to an enterprise reimbursement scenario according to one or more embodiments of this specification:

FIG. 4 is a schematic diagram of a reimbursement code-based data processing apparatus according to one or more embodiments of this specification: and

FIG. 5 is a schematic structural diagram of a reimbursement code-based data processing device according to one or more embodiments of this specification.

### DESCRIPTION OF EMBODIMENTS

To make a person skilled in the art understand the technical solutions in one or more embodiments of this specification better, the following clearly and comprehensively describes the technical solutions in the one or more embodiments of this specification with reference to the accompanying drawings in the one or more embodiments of this specification. Clearly, the described embodiments are merely some but not all of the embodiments of this specification. All other embodiments obtained by a person of ordinary skill in the art based on the one or more embodiments of this specification without creative efforts shall fall within the protection scope of this specification.

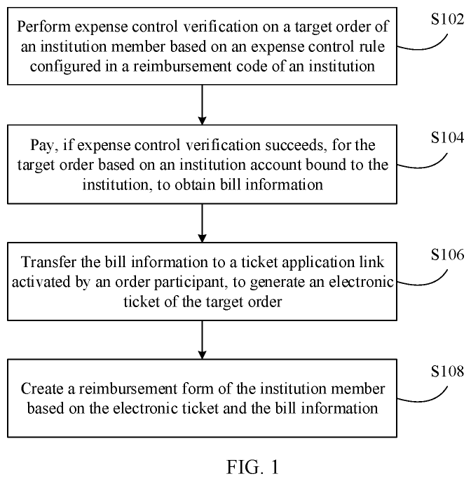

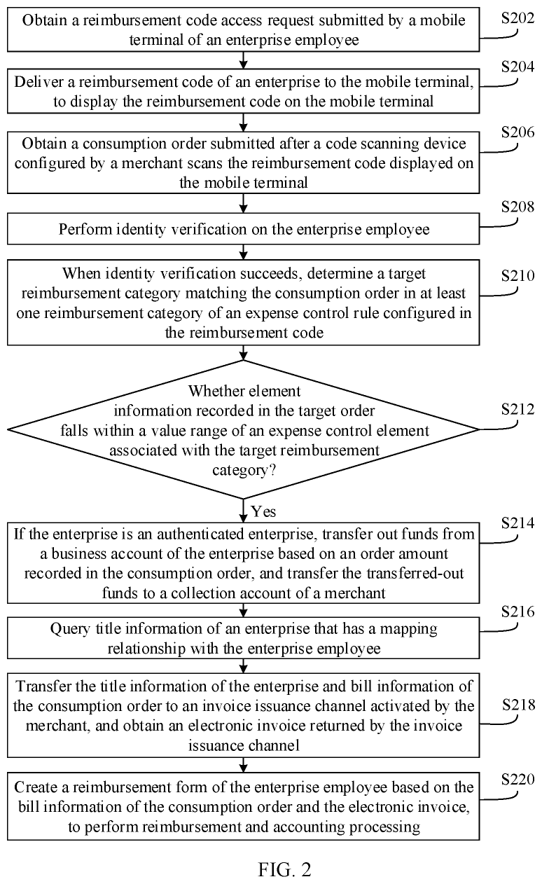

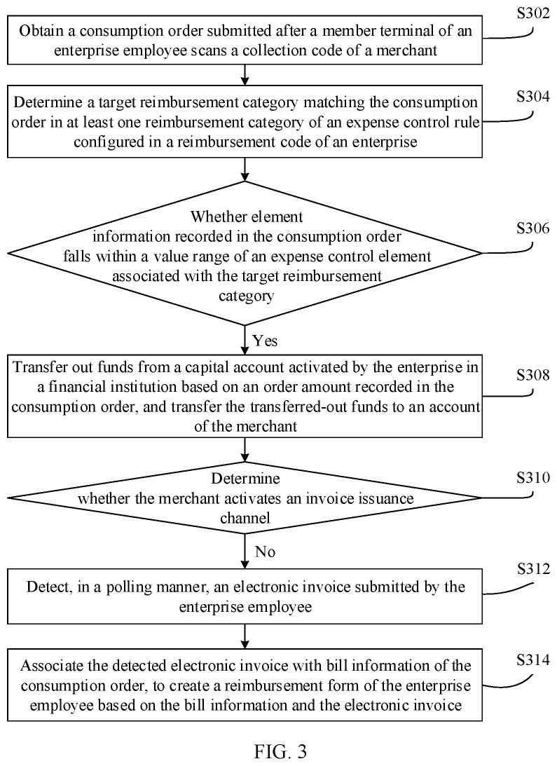

This specification provides an embodiment of a reimbursement code-based data processing method. FIG. 1 is a flowchart of processing of a reimbursement code-based data processing method according to an embodiment. FIG. 2 is a flowchart of processing of a reimbursement code based data processing method applied to an enterprise reimbursement scenario according to an embodiment. FIG. 3 is a flowchart of processing of a reimbursement code-based data processing method applied to an institution reimbursement scenario according to an embodiment.

Referring to FIG. 1, the reimbursement code-based data processing method provided in this embodiment specifically includes step S102 to step S108.

Step S102: Perform expense control verification on a target order of an institution member based on an expense control rule configured in a reimbursement code of an institution.

According to the reimbursement code-based data processing method provided in this embodiment, the reimbursement code of the institution is used as a core to perform integrated processing of payment, ticket issuance, and reimbursement on an order of the institution member in a specific scenario. Specifically, expense control verification is performed on the order of the institution member based on the expense control rule configured by the institution for the reimbursement code, to verify whether the order of the institution member meets a reimbursement condition of the institution. After verification succeeds, an expense is deducted from an institution account to perform order payment, an electronic ticket is issued for the order of the institution member through a ticket application link based on bill information obtained after payment, and a reimbursement form of the institution member is created based on the issued electronic ticket and the bill information, so that the institution performs reimbursement and accounting, to implement a closed loop of payment, ticket issuance, and reimbursement. In addition, an order, a bill, and a bill are associated, to resolve a problem that difficulty in reviewing authenticity is large in a reimbursement process, so that reimbursement review processing efficiency of the institution is improved, and processing efficiency and user experience of the institution member are improved.

The institution described in this embodiment includes various forms of organizations, including an enterprise, a public institution, a social group, an enterprise, and the like. In addition, the institution not only includes an organization at a current level, but also includes an internal organization of the institution, for example, an enterprise department or a division. The institution member includes institution staff and related personnel.

The reimbursement code is an institution code that is set by the institution for payment, ticket issuance, and reimbursement of the institution member. The institution code can uniquely identify the institution. An existence form of the institution code can be an identification code, for example, a two-dimensional code, a barcode, and an audio code. Integrated processing of payment, ticket issuance, and reimbursement can be implemented based on the reimbursement code. In addition, the reimbursement code can be further used to identify a member identity of the institution member in the institution. For example, the reimbursement code is used as a digital work card of an enterprise employee, and the enterprise employee can obtain, by using the reimbursement code as a credential, benefits and subsidies issued by the enterprise.

The expense control rule is used to verify whether an order submitted by the institution member meets a reimbursement condition set by the institution. For example, an enterprise code of the enterprise can be used by the enterprise employee to perform payment in scenarios such as travel on business, a business trip, hospitality, team building, office procurement, and benefit/subsidy issuance. A deducted expense generated by payment that meets a reimbursement condition that is set by the enterprise is borne by the enterprise, to realize automatic reimbursement or an employee discount. Optionally, the expense control rule is configured with at least one reimbursement category of the reimbursement code, and the reimbursement category is associated with at least one expense control element: and the expense control element includes at least one of the following: a time element, an object compliant element, a limit element, and a location element. The reimbursement category includes but is not limited to travel on business, a business trip, hospitality, team building, office procurement, and benefit/subsidy issuance.

The time element is used to verify whether a consumption time of reimbursement that is applied for by the institution member satisfies a stipulation of the institution. The object compliant element is used to verify whether a consumer of reimbursement that is applied for by the institution member satisfies a stipulation of the institution. For example, the enterprise stipulates that expense incurred by taking a company shuttle bus or a bus on a specific bus line can be reimbursed. If a vehicle that the enterprise employee takes does not satisfy a stipulation, reimbursement cannot be performed. The limit element is used to verify whether an amount of reimbursement that is applied for by the institution member satisfies a stipulation of the institution. The location element is used to verify whether geographic location information of a consumption location of reimbursement that is applied for by the institution member satisfies a stipulation of the institution.

In an optional implementation provided in this embodiment, in a process of activating the reimbursement code of the institution, whether the institution is an authenticated institution or whether an institution member who submits an obtained reimbursement code activation request is an institution possessor (for example, an enterprise possessor) of the institution is detected based on the reimbursement code activation request of the institution; and if yes, the reimbursement code is generated, and delivered to the institution or the institution member who submits the reimbursement code activation request, and a binding relationship between the institution and a submitted institution account is established, to deduct money from the institution account in a subsequent reimbursement process; or if no, it indicates that the institution does not satisfy a reimbursement code activation condition, and no processing is performed or reimbursement code activation failure reminder information is delivered to the institution.

When the institution activates the reimbursement code, the institution can actively invite the institution member to grant use permission for the reimbursement code, so that the institution member performs payment, ticket issuance, and reimbursement in scenarios such as travel on business, a business trip, hospitality, team building, office procurement, and benefit/subsidy issuance by using the reimbursement code. A process in which the institution actively invites the institution member to grant the use permission for the reimbursement code specifically includes: sending an activation invitation of the reimbursement code to a to-be-authorized member based on an activation request submitted by the institution for the to-be-authorized member: performing identity verification processing on the to-be-authorized member if a confirmation instruction submitted by the to-be-authorized member for the activation invitation is detected; and when identity verification processing succeeds, granting permission for the reimbursement code to the to-be-authorized member, and establishing a mapping relationship between the to-be-authorized member and institution keyword information of the institution. The institution keyword information includes title information of the institution.

After the institution grants the use permission for the reimbursement code to the institution member, the institution member can access the reimbursement code based on a reimbursement code service provided by a third-party application. For example, an enterprise employee to which permission for the reimbursement code is granted can access a reimbursement code of the enterprise based on a reimbursement code service of a payment application installed on a terminal of the institution member.

In addition, when the institution activates the reimbursement code, the institution member of the institution can alternatively actively apply for the use permission for the reimbursement code. The following content is specifically included: obtaining a permission granting application submitted by a to-be-authorized member after the to-be-authorized member uses a member terminal to scans an identification code of the institution, where the identification code includes the reimbursement code: reviewing the to-be-authorized member based on the permission granting application: and if review succeeds, granting permission for the reimbursement code to the to-be-authorized member, and establishing a mapping relationship between the to-be-authorized member and institution keyword information of the institution.

In an actual application, in addition to a case in which the institution member and the institution sign a labor contract to establish a fixed contract relationship, there may be special cases such as a temporary assignment, a part-time job, and cross-department collaboration, to make a relationship between the institution and the institution member more complicated, so that one member may have a cooperative relationship or a subordinate relationship with a plurality of institutions. In view of this, optionally, if a plurality of institutions have a subordinate relationship with the institution member, the reimbursement code service is configured with reimbursement code access entries of a plurality of institutions or a plurality of reimbursement code presentation pages: and the reimbursement code service is configured with a switching control for switching from a reimbursement code access entry of one institution to a reimbursement code access entry of another institution, or a switching control for switching from a reimbursement code display page of one institution to a reimbursement code display page of another institution, so that the institution member accesses and uses reimbursement codes of the plurality of institutions.

In this embodiment, in a process in which the institution member uses the reimbursement code of the institution, two access modes of a “scanning” mode and a “scanned” mode are provided to the institution member, so that the institution member accesses and uses the reimbursement code. In the “scanned” mode, the institution member actively displays the reimbursement code of the institution to a merchant or another type of transaction party, and the merchant or the another type of transaction party scans, by using a scanning device, the reimbursement code displayed by the institution member, to perform payment, ticket issuance, and reimbursement processing on the order of the institution member. Specifically, a reimbursement code access request submitted by a member terminal of the institution member is obtained: and the reimbursement code of the institution is delivered to the member terminal, to display the reimbursement code on the member terminal, where the target order is submitted after a code scanning device configured for the order participant scans the reimbursement code displayed on the member terminal. The order participant is another participant recorded in the target order of the institution member, including the merchant or the another type of transaction party. In the “scanning” mode, a terminal of the institution member scans a transaction code of the merchant or the another type of transaction party by accessing a code scanning interface provided by the reimbursement code service, to generate an order, and when the order is generated, performs payment, ticket issuance, and reimbursement processing on the order by using the reimbursement code of the institution. Specifically, the target order submitted after a member terminal of the institution member scans a transaction code of the order participant is obtained. The institution member accesses a code scanning control of a reimbursement code service configured for a third-party application, to invoke an image capturing component configured for the member terminal to scan the transaction code.

In a specific implementation, in a process of performing expense control verification on the target order of the institution member based on the expense control rule configured in the reimbursement code of the institution, a target reimbursement category matching the target order in at least one reimbursement category of the expense control rule is determined: whether element information recorded in the target order falls within a value range of an expense control element associated with the target reimbursement category is verified; and if yes, it is determined that verification on the target order in terms of the target reimbursement category succeeds. In other words, a verification result of performing expense control verification on the target order is that verification succeeds. Alternatively, if no, it is determined that verification on the target order in terms of the target reimbursement category fails. In other words, a verification result of performing expense control verification on the target order is that verification fails.

Specifically, when expense control verification fails, reimbursement failure reminder information is delivered to the institution member, funds are transferred out from a member account of the institution member, and the transferred-out funds are transferred to an account of the order participant, to ensure that processing of the target order of the institution member is not interrupted.

It should be noted that verifying whether the element information recorded in the target order falls within the value range of the expense control element associated with the target reimbursement category is specifically verifying whether each piece of element information recorded in the target order satisfies a corresponding expense control element, that is, whether each piece of element information falls within a value range of the corresponding expense control element. If any element information is outside a value range of a corresponding expense control element, it is determined that verification on the target order in terms of the target reimbursement category fails. If each piece of element information falls within the value range of the corresponding expense control element of the element information, it is determined that verification on the target order in terms of the target reimbursement category succeeds.

For example, if the enterprise employee submits a consumption order, and the consumption order is a ticket order and matches a travel on business category in an expense control rule configured in a reimbursement code of the enterprise, whether element information recorded in the consumption order satisfies a time element, a vehicle type element, and a limit element that are associated with the travel on business category is verified. Specifically, whether time information recorded in the consumption order satisfies a value range of the time element is verified (a travel on business time is from xx (Month) 1 (day), xx (Year) to xx (Month) 3 (day), xx (Year)), whether vehicle information recorded in the consumption order satisfies a value range of the vehicle element is verified (a travel on business reimbursement vehicle type includes a hard seat and a hard seat of an ordinary train), and whether amount information recorded in the consumption order satisfies a value range of the limit element is verified (a maximum reimbursement limit is 1000 yuan for a single time).

In an actual application, a single target order of the institution member may satisfy a plurality of reimbursement conditions configured in the expense control rule of the institution. In other words, a plurality of reimbursement categories in the expense control rule match the target order of the institution member, and review, of the element information recorded in the target order, in terms of expense control elements associated with the plurality of reimbursement categories succeeds. Optionally, if verification on the target order in terms of a plurality of target reimbursement categories succeeds, the following operations are performed: using, based on a priority sequence of the target reimbursement categories, a reimbursement category with a highest priority in the plurality of matched target reimbursement categories as an expense control reimbursement category: or displaying the plurality of matched target reimbursement categories to the institution member, and using, as an expense control reimbursement category, a target reimbursement category selected by the institution member from the plurality of displayed target reimbursement categories: or determining an expense control reimbursement category from the plurality of matched target reimbursement categories based on historical reimbursement data of the institution member.

In this embodiment, in a process of determining the target reimbursement category matching the target order in the at least one reimbursement category of the expense control rule, whether the target order matches a plurality of reimbursement categories of the expense control rule is detected; and if yes, a reimbursement category with a highest priority in the plurality of matched reimbursement categories is used as the target reimbursement category based on a priority sequence of the reimbursement categories; or the plurality of matched reimbursement categories are displayed to the institution member, and a reimbursement category selected by the institution member from the plurality of displayed reimbursement categories is used as the target reimbursement category: or the target reimbursement category is determined from the plurality of matched reimbursement categories based on historical reimbursement data of the institution member.

In addition, when a verification result of performing expense control verification on the target order is that verification fails, in an optional implementation provided in this embodiment, if an execution result of the step of verifying whether the element information recorded in the target order falls within the value range of the expense control element associated with the target reimbursement category is no, a non-compliant element that is in the element information recorded in the target order and that is outside the value range of the expense control element associated with the target reimbursement category is further determined; and expense control reminder information is generated based on the non-compliant element and corresponding element information, and the expense control reminder information is delivered to the institution member, so that the institution member perceives the expense control rule configured in the reimbursement code, to improve a success rate of performing subsequent payment, ticket issuance, and reimbursement processing by the institution member by using the reimbursement code.

Further, to improve the success rate of performing payment, ticket issuance, and reimbursement processing by an institution member by using the reimbursement code, and further improve reimbursement code use experience of the institution member, in an optional implementation provided in this embodiment, if the non-compliant element included in the expense control reminder information is a limit element, the following operations are performed: performing order splitting on the target order based on an upper limit threshold of a value range of the limit element, to obtain a first order and a second sub-order whose order amount is equal to a maximum limit threshold; transferring out funds from the institution account based on the order amount of the second sub-order, and transferring the transferred-out funds to an account of the order participant: and transferring out funds from a member account of the institution member based on an order amount of the first order, and transferring the transferred-out funds to the account of the order participant.

In addition, the target order can be updated or replaced by using the second sub-order obtained after splitting, and a subsequent payment, ticket issuance, and reimbursement processing process of the target order can be performed based on this.

The following provides two specific implementations in an expense control verification processing process: Implementation 1: (1) Determine a target reimbursement category matching the target order in at least one reimbursement category of the expense control rule.

Specifically, the target reimbursement category can be determined in the following manner: detecting whether the target order matches a plurality of reimbursement categories of the expense control rule: and if yes, using a reimbursement category with a highest priority in the plurality of matched reimbursement categories as the target reimbursement category based on a priority sequence of the reimbursement categories: or displaying the plurality of matched reimbursement categories to the institution member, and using, as the target reimbursement category, a reimbursement category selected by the institution member from the plurality of displayed reimbursement categories: or determining the target reimbursement category from the plurality of matched reimbursement categories based on historical reimbursement data of the institution member: or if no, performing sub-step (2).

(2) Verify whether element information recorded in the target order falls within a value range of an expense control element associated with the target reimbursement category: and if yes, determine that verification on the target order in terms of the target reimbursement category succeeds.

If no, sub-step (3) and sub-step (4) are performed.

(3) Determine a non-compliant element that is in the element information recorded in the target order and that is outside the value range of the expense control element associated with the target reimbursement category.

(4) Generate expense control reminder information based on the non-compliant element and corresponding element information, and deliver the expense control reminder information to the institution member.

In addition, implementations of sub-step (3) and sub-step (4) can be further replaced with the following implementations: determining a non-compliant element that is of the target order and whose expense control verification fails, and generating expense control reminder information based on the non-compliant element.

If the non-compliant element included in the expense control reminder information is a limit element, sub-step (5) to sub-step (7) are performed.

(5) Perform order splitting on the target order based on an upper limit threshold of a value range of the limit element, to obtain a first order and a second sub-order whose order amount is equal to a maximum limit threshold.

(6) Transfer out funds from the institution account based on the order amount of the second sub-order, and transfer the transferred-out funds to an account of the order participant.

(7) Transfer out funds from a member account of the institution member based on an order amount of the first order, and transfer the transferred-out funds to the account of the order participant.

Implementation 2: (1) Perform expense control verification on the target order of the institution member based on the expense control rule configured in the reimbursement code of the institution: and if expense control verification succeeds, perform step S104 to perform payment processing: or if expense control verification fails, perform sub-step (2).

(2) Determine a non-compliant element that is of the target order and whose expense control verification fails, and generate expense control reminder information based on the non-compliant element.

If the non-compliant element is the limit element, funds are transferred out from the institution account based on the upper limit threshold of the value range of the limit element, funds are transferred out from the member account of the institution member based on a remaining order amount, and the transferred-out fund is transferred to an account of the order participant. The remaining order amount is equal to a difference between an order amount of the target order and the upper limit threshold of the value range of the limit element.

It should be noted that, for the two provided specific implementations of expense control verification, when expense control verification succeeds, whether the target order matches a plurality of reimbursement categories of the expense control rule can be further detected.

If yes, a reimbursement category with a highest priority in the plurality of matched target reimbursement categories is used as an expense control reimbursement category based on a priority sequence of target reimbursement categories; or the plurality of matched target reimbursement categories are displayed to the institution member, and a target reimbursement category selected by the institution member from the plurality of displayed target reimbursement categories is used as an expense control reimbursement category: or an expense control reimbursement category is determined from the plurality of matched target reimbursement categories based on historical reimbursement data of the institution member. Alternatively, if no, it indicates that the target order matches only one reimbursement category of the expense control rule, and no processing is performed.

Based on this, a subsequent process of paying for the target order based on the institution account bound to the institution can be further replaced with transferring out, based on the expense control reimbursement category or the target expense control category, funds from the institution account bound to the institution, to pay for the target order, and recording the expense control reimbursement category or the target expense control category in the bill information obtained after payment.

Step S104: Pay, if expense control verification succeeds, for the target order based on the institution account bound to the institution, to obtain the bill information.

In this embodiment, after verification on the target order of the institution member succeeds in terms of the expense control rule, the target order is paid for based on the institution account bound to the institution. Specifically, in a payment processing process, if the institution is an authenticated institution, funds are transferred out from a business account of the institution based on an order amount recorded in the target order, and the transferred-out funds are transferred to an account of the order participant.

In fact, many small and micro enterprises do not activate a business account or perform real name authentication. Therefore, to help these institutions use the reimbursement code to perform reimbursement processing, if the institution is a non-authenticated institution, funds are transferred out from a possessor's account of an institution processor based on an order amount recorded in the target order, and the transferred-out funds are transferred to an account of the order participant.

In addition, in order that an initiative of the institution to use the reimbursement code service is promoted from a perspective of the institution, in this embodiment, a financial institution is introduced into the reimbursement code service, the institution activates a financial account in the financial institution and serves as an actual fund expenditure party who pays for the target order of the institution member, and then the institution reimburses the financial institution in a corresponding billing period. In an optional implementation provided in this embodiment, the institution account includes a financial account activated by the financial institution, for example, a capital account, a credit account, or a billing period account for which settlement is performed in a billing period settlement manner. Correspondingly, that the target order is paid for based on the institution account bound to the institution specifically includes: transferring out funds from the financial account based on an order amount recorded in the target order, and transferring the transferred-out funds to an account of the order participant.

Optionally, the funds transferred out from the financial account are prepaid by the financial institution, and the institution reimburses the financial institution for the prepaid funds in an agreed billing period.

Step S106: Transfer the bill information to a ticket application link activated by an order participant, to generate an electronic ticket of the target order.

The electronic ticket in this embodiment includes electronic credentials such as an electronic invoice and a receipt that have a credential effect. The ticket application link is a channel for issuing an electronic ticket, for example, an electronic invoice issuance interface provided by a tax institution.

In a specific implementation, when the order participant activates the ticket application link of the target order and the order participant enables automatic issuance of the electronic ticket, the bill information is transferred to a ticket application link associated with the member order, and the electronic ticket that is of the target order and that is returned by the ticket application link is obtained. Alternatively, institution keyword information that has a mapping relationship with the institution member is queried: and the bill information is transferred to a ticket application link associated with the member order, and the electronic ticket that is of the target order and that is returned by the ticket application link is obtained. The ticket application link issues the electronic ticket based on the bill information and the institution keyword information synchronized from the institution.

If the order participant activates the ticket application link of the target order, but the order participant does not enable automatic issuance of the electronic ticket, a payment completion page or a bill presentation page of the target order is delivered to the institution member. The payment completion page and the bill presentation page are configured with a ticket application control of the target order. If a trigger instruction of the ticket application control is detected, the bill information is transferred to the ticket application link, and the electronic ticket that is of the target order and that is returned by the ticket application link is obtained. The ticket application link issues the electronic ticket based on pre-stored or obtained institution keyword information of the institution and the bill information.

In addition, if the order participant does not activate the ticket application link, or does not activate the ticket application link of the electronic ticket, a ticket needs to be issued by the institution member or the order participant. For example, an electronic invoice of a consumption order is issued offline or an electronic invoice is issued by using a third-party application. In an optional implementation provided in this embodiment, reimbursement processing is further performed based on this. In a specific implementation process, before the bill information is transferred to the ticket application link activated by the order participant, to generate the electronic ticket of the target order, whether the order participant activates the ticket application link is determined; and if yes, the process of transferring the bill information to a ticket application link activated by an order participant, to generate an electronic ticket of the target order is executed: or if not, an electronic ticket submitted by the institution member or the order participant is detected in a polling manner, and the submitted electronic ticket is associated with the bill information of the target order, to create a reimbursement form of the institution user based on the submitted electronic ticket and the bill information.

It should be noted that the process of transferring the bill information to a ticket application link activated by an order participant, to generate an electronic ticket of the target order can be further replaced with transferring, to the ticket application link activated by the order participant, the bill information and institution keyword information to which the institution member is mapped, to generate the electronic ticket of the target order.

Step S108: Create a reimbursement form of the institution member based on the electronic ticket and the bill information.

Based on a case in which payment processing is performed on the target order to obtain the bill information, and the electronic ticket of the target order is generated by using the ticket application link, in this step, the reimbursement form of the institution member is created based on the electronic ticket of the target order and the bill information of the target order, so that the institution performs reimbursement and accounting, to implement automatic reimbursement processing.

In an optional implementation provided in this embodiment, to improve authenticity of performing reimbursement and accounting by the institution member, in a process of creating the reimbursement form of the institution member based on the electronic ticket and the bill information, authenticity of the electronic ticket and the bill information is verified: and after verification succeeds, the reimbursement form of the institution member is created based on ticket key information recorded in the electronic ticket and/or bill key information included in the bill information.

To further improve authenticity of performing reimbursement and accounting by the institution member, the reimbursement form of the institution member can be further created based on the target order, the bill information, and the electronic ticket, so that the institution member performs reimbursement and accounting. Specifically, authenticity of reimbursement is improved by verifying the target order, the bill information, and the electronic ticket.

In addition, to help the institution member collect the electronic ticket, and improve efficiency of reviewing reimbursement by the institution, a relationship among the target order, the bill information, and the electronic ticket is established at a data level by integrating the target order, the bill information, and the electronic ticket, to resolve a problem that reviewing authenticity of reimbursement is difficult. Specifically, the target order, the bill information, and the electronic ticket can be integrated by establishing a binding relationship or a mapping relationship among the target order, the bill information, and the electronic ticket, or by combining the target order, the bill information, and the electronic ticket or splicing the target order, the bill information, and the electronic ticket into an electronic credential.

In an actual application, combined reimbursement is performed for bills in many scenarios. A business trip scenario of the institution member is used as an example. The institution member can perform combined reimbursement for all consumption bills in a journey of one business trip, or the institution member can perform combined reimbursement for a plurality of riding consumption bills in a journey of one business trip, and can further perform combined reimbursement for a plurality of food and beverage consumption bills. In view of this, to improve reimbursement processing efficiency, in an optional implementation provided in this embodiment, in a process of creating the reimbursement form of the institution member based on the electronic ticket and the bill information, combined reimbursement is implemented in the following manner: analyzing a payment on business relationship between a plurality of target orders based on element information included in bill information of the plurality of target orders: and combining the plurality of target orders based on the payment on business relationship, and creating a reimbursement form of the institution member for a payment on business journey based on a combination result and electronic tickets of the plurality of target orders.

It should be noted that a specific implementation process of combined reimbursement is described herein by using the business trip scenario as an example. Combined reimbursement can also be implemented for scenarios such as travel on business, hospitality, team building, office procurement, and benefit/subsidy issuance. For a specific implementation process, refer to the foregoing implementation of performing combined reimbursement for the business trip scenario. Details are not described herein again in this embodiment.

The following further describes, by using an example in which a reimbursement code-based data processing method is applied to an enterprise reimbursement scenario in embodiments, the reimbursement code-based data processing method provided in the embodiments. Referring to FIG. 2, the reimbursement code-based data processing method applied in the enterprise reimbursement scenario specifically includes step S202 to step S220.

Step S202: Obtain a reimbursement code access request submitted by a mobile terminal of an enterprise employee.

Step S204: Deliver a reimbursement code of an enterprise to the mobile terminal, to display the reimbursement code on the mobile terminal.

Step S206: Obtain a consumption order submitted after a code scanning device configured by a merchant scans the reimbursement code displayed on the mobile terminal.

Step S208: Perform identity verification on the enterprise employee.

Step S210: When identity verification succeeds, determine a target reimbursement category matching the consumption order in at least one reimbursement category of an expense control rule configured in the reimbursement code.

Step S212: Verify whether element information recorded in the consumption order falls within a value range of an expense control element associated with the target reimbursement category: and if yes, determine that verification on the consumption order in terms of the target reimbursement category succeeds, and perform step S214; or if not, send reimbursement failure reminder information to the enterprise employee, transfer out funds from a capital account of the enterprise employee, and transfer the transferred-out funds to a collection account of the merchant.

Step S214: If the enterprise is an authenticated enterprise, transfer out funds from a business account of the enterprise based on an order amount recorded in the consumption order, and transfer the transferred-out funds to the collection account of the merchant.

Step S216: Query title information of an enterprise that has a mapping relationship with the enterprise employee.

Step S218: Transfer the title information of the enterprise and bill information of the consumption order to an invoice issuance channel activated by the merchant, and obtain an electronic invoice returned by the invoice issuance channel.

Step S220: Create a reimbursement form of the enterprise employee based on the bill information of the consumption order and the electronic invoice, to perform reimbursement and accounting processing.

The following further describes, by using an example in which a reimbursement code-based data processing method is applied to an enterprise reimbursement scenario in embodiments, the reimbursement code-based data processing method provided in the embodiments. Referring to FIG. 3, the reimbursement code-based data processing method applied in the enterprise reimbursement scenario specifically includes step S302 to step S314.

Step S302: Obtain a consumption order submitted after a member terminal of an enterprise employee scans a collection code of a merchant.

Step S304: Determine a target reimbursement category matching the consumption order in at least one reimbursement category of an expense control rule configured in a reimbursement code of an enterprise.

Step S306: Verify whether element information recorded in the consumption order falls within a value range of an expense control element associated with the target reimbursement category: and if yes, determine that verification on the consumption order in terms of the target reimbursement category succeeds, and perform step S308: or if no, transfer out funds from a capital account of the enterprise employee, transfer the transferred-out funds to a collection account of the merchant, determine a non-compliant element that is in the element information recorded in the target order and that is outside the value range of the expense control element associated with the target reimbursement category, generate expense control reminder information based on the non-compliant element and corresponding element information, and deliver the expense control reminder information to the institution member.

Step S308: Transfer out funds from a capital account activated by the enterprise in a financial institution based on an order amount recorded in the consumption order, and transfer the transferred-out funds to an account of the merchant.

The funds transferred out from the capital account activated by the enterprise in the financial institution are prepaid by the financial institution, and the enterprise reimburses the financial institution for the prepaid funds in an agreed billing period.

Step S310: Determine whether the merchant activates an invoice issuance channel: and if yes, deliver a payment completion page of the consumption order to the enterprise employee, where the payment completion page is configured with a ticket issuance control of the consumption order, and if a trigger instruction of the ticket issuance control is detected, transfer bill information to the invoice issuance channel, and obtain an electronic invoice returned by the invoice issuance channel: or if no, perform step S312 and step S314.

Step S312: Detect, in a polling manner, an electronic invoice submitted by the enterprise employee.

Step S314: Associate the detected electronic invoice with the bill information of the consumption order, to create the reimbursement form of the enterprise employee based on the bill information and the electronic invoice.

An embodiment of a reimbursement code-based data processing apparatus provided in this specification is as follows: The foregoing embodiment provides a reimbursement code-based data processing method. Correspondingly, a reimbursement code-based data processing apparatus is further provided, and is described below with reference to the accompanying drawings.

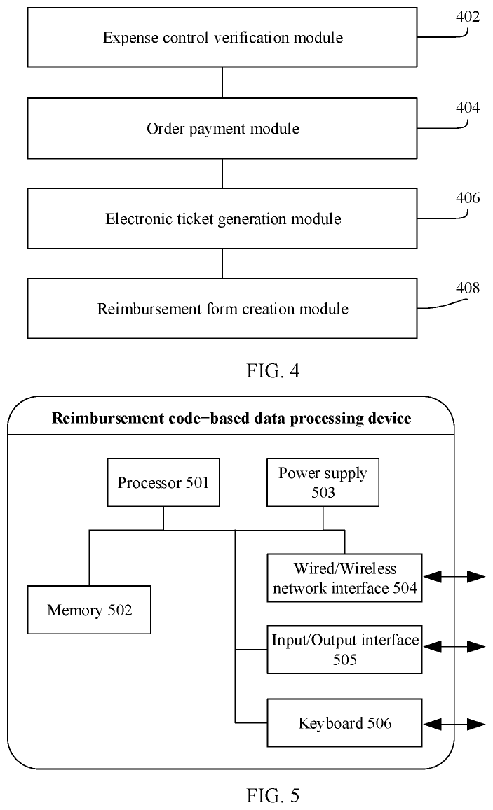

FIG. 4 is a schematic diagram of a reimbursement code-based data processing apparatus according to an embodiment.

The apparatus embodiment corresponds to the method embodiment, and therefore, is briefly described. For a related part, refer to the corresponding description of the method embodiment. The following described apparatus embodiment is merely an example.

This embodiment provides a reimbursement code-based data processing apparatus, including: an expense control verification module 402, configured to perform expense control verification on a target order of an institution member based on an expense control rule configured in a reimbursement code of an institution: an order payment module 404, configured to pay, if expense control verification succeeds, for the target order based on an institution account bound to the institution, to obtain bill information: an electronic ticket generation module 406, configured to transfer the bill information to a ticket application link activated by an order participant, to generate an electronic ticket of the target order: and a reimbursement form creation module 408, configured to create a reimbursement form of the institution member based on the electronic ticket and the bill information.

An embodiment of a reimbursement code-based data processing device provided in this specification is as follows: Corresponding to the reimbursement code-based data processing method, based on the same technical concept, one or more embodiments of this specification further provide a reimbursement code-based data processing device. The reimbursement code-based data processing device is configured to perform the foregoing provided reimbursement code-based data processing method. FIG. 5 is a schematic structural diagram of a reimbursement code-based data processing device according to one or more embodiments of this specification.

The reimbursement code-based data processing device provided in this embodiment includes: As shown in FIG. 5, the reimbursement code-based data processing device can differ greatly due to different configurations or performance, and can include one or more processors 501 and a storage 502. The storage 502 can store one or more storage applications or data. The storage 502 can be a temporary storage or a persistent storage. The application program stored in the storage 502 can include one or more modules (not shown in the figure), and each module can include a series of computer-executable instructions in the reimbursement code-based data processing device. Still further, the processor 501 can be configured to communicate with the storage 502, to execute a series of computer-executable instructions in the storage 502 on the reimbursement code-based data processing device. The reimbursement code-based data processing device can further include one or more power supplies 503, one or more wired or wireless network interfaces 504, one or more input/output interfaces 505, one or more keypads 506, etc.

In a specific embodiment, the reimbursement code-based data processing device includes a storage and one or more programs. The one or more programs are stored in the storage, the one or more programs can include one or more modules, and each module can include a series of computer-executable instructions in the reimbursement code-based data processing device, and is configured to perform, by using the one or more processors, the following computer-executable instructions: performing expense control verification on a target order of an institution member based on an expense control rule configured in a reimbursement code of an institution; paying, if expense control verification succeeds, for the target order based on an institution account bound to the institution, to obtain bill information; transferring the bill information to a ticket application link activated by an order participant, to generate an electronic ticket of the target order: and creating a reimbursement form of the institution member based on the electronic ticket and the bill information.

An embodiment of a storage medium provided in this specification is as follows: Corresponding to the foregoing described reimbursement code-based data processing method, based on the same technical concept, one or more embodiments of this specification further provide a storage medium.

The storage medium provided in this embodiment is configured to store computer-executable instructions. When the computer-executable instructions are executed, the following procedure is implemented: performing expense control verification on a target order of an institution member based on an expense control rule configured in a reimbursement code of an institution: paying, if expense control verification succeeds, for the target order based on an institution account bound to the institution, to obtain bill information: transferring the bill information to a ticket application link activated by an order participant, to generate an electronic ticket of the target order: and creating a reimbursement form of the institution member based on the electronic ticket and the bill information.

It should be noted that the embodiment of the storage medium in this specification is based on the same inventive concept as the embodiment of the reimbursement code-based data processing method in this specification. Therefore, for a specific implementation of this embodiment, references can be made to the corresponding implementation of the reimbursement code-based data processing method, and repeated parts are omitted for simplicity.

Specific embodiments of this specification are described above. Other embodiments fall within the scope of the appended claims. In some cases, actions or steps described in the claims can be performed in a sequence different from that in some embodiments and desired results can still be achieved. In addition, the process depicted in the accompanying drawings does not necessarily need a particular order or consecutive order to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved using a hardware entity module. For example, a programmable logic device (PLD) (for example, a field programmable gate array (FPGA)) is such an integrated circuit, and a logical function of the programmable logic device is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can also be implemented as a part of the control logic of the storage. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the embedded microcontroller, etc. Therefore, the controller can be considered as a hardware component, and an apparatus included in the controller for implementing various functions can also be considered as a structure in the hardware component. Alternatively, the apparatus configured to implement various functions can even be considered as both a software module implementing the method and a structure in the hardware component.

The system, apparatus, module, or unit illustrated in the previous embodiments can be implemented by using a computer chip or an entity, or can be implemented by using a product having a certain function. A typical implementation device is a computer. Specifically, for example, the computer can be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the above-mentioned apparatus is described by dividing functions into various units. Certainly, when the embodiments of this specification are implemented, a function of each unit can be implemented in one or more pieces of software and/or hardware.

A person skilled in the art should understand that one or more embodiments of this application can be provided as a method, a system, or a computer program product. Therefore, the one or more embodiments of this specification can use a form of hardware only embodiments, software only embodiments, or embodiments with a combination of software and hardware. In addition, a form of a computer program product that is implemented on one or more computer-usable storage media (including but not limited to a disk storage, a CD-ROM, an optical storage, etc.) that include computer-usable program code can be used in this specification.

This specification is described with reference to the flowcharts and/or block diagrams of the method, the device (system), and the computer program product based on the embodiments of this specification. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer-readable storage that can instruct the computer or the another programmable data processing device to work in a specific way, so the instructions stored in the computer-readable storage generate an artifact that includes an instruction apparatus. The instruction apparatus implements a specific function in one or more processes in the flowcharts and/or in one or more blocks in the block diagrams.

These computer program instructions can alternatively be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory may include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes a persistent and a non-persistent, a removable and a non-removable medium, which can implement information storage by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), a random access memory (RAM) of another type, a read-only memory (ROM), an electrically erasable programmable read-only memory (EEPROM), a flash memory or another memory technology, a compact disc read-only memory (CD-ROM), a digital versatile disc (DVD) or another optical storage, a cassette, a magnetic disk storage or another magnetic storage device, or any other non-transmission medium. The computer storage medium can be configured to store information that can be accessed by a computing device. As described in this specification, the computer-readable medium does not include computer-readable transitory media such as a modulated data signal and a carrier.

It should be further noted that, the terms “include”, “comprise”, or any other variant thereof are intended to cover a non-exclusive inclusion such that a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

One or more embodiments of this specification can be described in the general context of computer-executable instructions, for example, a program module. Usually, the program module includes a routine, a program, an object, a component, a data structure, etc. executing a specific task or implementing a specific abstract data type. The one or more embodiments of this specification can also be practiced in distributed computing environments. In the distributed computing environments, tasks are performed by remote processing devices that are connected through a communication network. In a distributed computing environment, the program module can be located in both local and remote computer storage media including storage devices.

Some embodiments of this specification are described in a progressive way. For same or similar parts of some embodiments, mutual references can be made to the embodiments. Each embodiment focuses on a difference from other embodiments. Particularly, a system embodiment is similar to a method embodiment, and therefore is described briefly. For related parts, reference can be made to partial descriptions in the method embodiment.

The previous descriptions are merely some embodiments of this specification and are not intended to limit this specification. A person skilled in the art can make various modifications and changes to this specification. Any modification, equivalent replacement, or improvement made without departing from the spirit and principle of this specification shall fall within the scope of the claims of this specification.

1. A reimbursement method, comprising:
performing expense control verification on a target order of an institution member based on an expense control rule configured in a reimbursement code of an institution;
paying, upon determining that expense control verification succeeds, for the target order based on an institution account bound to the institution, to obtain bill information;
transferring the bill information to a ticket application link activated by an order participant, to generate an electronic ticket of the target order; and
creating a reimbursement form of the institution member based on the electronic ticket and the bill information.

2. The reimbursement method according to claim 1, wherein the performing expense control verification on a target order of an institution member based on an expense control rule configured in a reimbursement code of an institution comprises:
determining a target reimbursement category matching the target order in at least one reimbursement category of the expense control rule;
verifying whether element information recorded in the target order falls within a value range of an expense control element associated with the target reimbursement category; and
upon determining that element information recorded in the target order falls within the value range of the expense control element associated with the target reimbursement category, determining that verification on the target order in terms of the target reimbursement category succeeds.

3. The reimbursement method according to claim 1, wherein the expense control rule is configured with at least one reimbursement category of the reimbursement code, and the reimbursement category is associated with at least one expense control element; and
the expense control element comprises at least one of the following: a time element, an object compliant element, a limit element, and a location element.

4. The reimbursement method according to claim 1, wherein before the step of performing expense control verification on a target order of an institution member based on an expense control rule configured in a reimbursement code of an institution is performed, the method further comprises:
obtaining a reimbursement code access request submitted by a member terminal of the institution member; and
delivering the reimbursement code of the institution to the member terminal, to display the reimbursement code on the member terminal, wherein the target order is submitted after a code scanning device configured for the order participant scans the reimbursement code displayed on the member terminal.

5. The reimbursement method according to claim 1, wherein before the step of performing expense control verification on a target order of an institution member based on an expense control rule configured in a reimbursement code of an institution is performed, the method further comprises:
obtaining the target order submitted after a member terminal of the institution member scans a transaction code of the order participant, wherein
the institution member accesses a code scanning control of a reimbursement code service configured for a third-party application, to invoke an image capturing component configured for the member terminal to scan the transaction code.

6. The reimbursement method according to claim 1, further comprising:
detecting, based on an obtained reimbursement code activation request of the institution, whether the institution is an authenticated institution or whether an institution member who submits the reimbursement code activation request is an institution possessor of the institution; and
upon determining that the institution is an authenticated institution or an institution member who submits the reimbursement code activation request is an institution possessor of the institution, generating the reimbursement code, delivering the reimbursement code to the institution or the institution member who submits the reimbursement code activation request, and establishing a binding relationship between the institution and a submitted institution account.

7. (canceled)

8. (canceled)

9. The reimbursement method according to claim 1, wherein the paying for the target order based on an institution account bound to the institution comprises:
upon determining that the institution is an authenticated institution, transferring out funds from a business account of the institution based on an order amount recorded in the target order, and transferring the transferred-out funds to an account of the order participant; or
upon determining that the institution is a non-authenticated institution, transferring out funds from a possessor's account of an institution processor based on an order amount recorded in the target order, and transferring the transferred-out funds to an account of the order participant.

10. The reimbursement method according to claim 1, wherein the institution account comprises a financial account that is activated by the institution at a financial institution; and
correspondingly, the paying for the target order based on an institution account bound to the institution comprises:
transferring out funds from the financial account based on an order amount recorded in the target order, and transferring the transferred-out funds to an account of the order participant.

11. (canceled)

12. The reimbursement method according to claim 1, wherein the transferring the bill information to a ticket application link activated by an order participant, to generate an electronic ticket of the target order comprises:
querying institution keyword information that has a mapping relationship with the institution member; and
transferring the bill information to a ticket application link associated with the member order, and obtaining the electronic ticket that is of the target order and that is returned by the ticket application link, wherein the ticket application link issues the electronic ticket based on the bill information and the institution keyword information synchronized from the institution.

13. The reimbursement method according to claim 1, wherein the transferring the bill information to a ticket application link activated by an order participant, to generate an electronic ticket of the target order comprises:
delivering a payment completion page or a bill presentation page of the target order to the institution member, wherein the payment completion page and the bill presentation page are configured with a ticket application control of the target order; and
upon determining that a trigger instruction of the ticket application control is detected, transferring the bill information to the ticket application link, and obtaining the electronic ticket that is of the target order and that is returned by the ticket application link.

14. The reimbursement method according to claim 1, wherein after the step of paying, upon determining that expense control verification succeeds, for the target order based on an institution account bound to the institution, to obtain bill information, and before the step of transferring the bill information to a ticket application link activated by an order participant, to generate an electronic ticket of the target order is performed, the method further comprises:
determining whether the order participant activates the ticket application link; and
upon determining that the order participant activates the ticket application link, performing the step of transferring the bill information to a ticket application link activated by an order participant, to generate an electronic ticket of the target order; or
upon determining that the order participant does not activate the ticket application link, detecting, in a polling manner, an electronic ticket submitted by the institution member or the order participant, and associating the submitted electronic ticket with the bill information of the target order, to create a reimbursement form of the institution member based on the submitted electronic ticket and the bill information.

15. The reimbursement method according to claim 1, wherein the institution member accesses the reimbursement code by using a reimbursement code service provided by a third-party application;
upon determining that a plurality of institutions have a subordinate relationship with the institution member, the reimbursement code service is configured with reimbursement code access entries of a plurality of institutions or a plurality of reimbursement code presentation pages; and
the reimbursement code service is configured with a switching control for switching from a reimbursement code access entry of one institution to a reimbursement code access entry of another institution, or a switching control for switching from a reimbursement code display page of one institution to a reimbursement code display page of another institution.

16. The reimbursement method according to claim 1, further comprising:
upon determining that expense control verification fails, delivering reimbursement failure reminder information to the institution member, and/or transferring out funds from a member account of the institution member, and transferring the transferred-out funds to an account of the order participant.

17. The reimbursement method according to claim 1, wherein the creating a reimbursement form of the institution member based on the electronic ticket and the bill information comprises:
verifying authenticity of the electronic ticket and the bill information; and
after verification succeeds, creating the reimbursement form of the institution member based on ticket key information recorded in the electronic ticket and/or bill key information comprised in the bill information.

18. The reimbursement method according to claim 1, wherein the creating a reimbursement form of the institution member based on the electronic ticket and the bill information comprises:
analyzing a payment on business relationship between a plurality of target orders based on element information comprised in bill information of the plurality of target orders; and
combining the plurality of target orders based on the payment on business relationship, and creating a reimbursement form of the institution member for a payment on business journey based on a combination result and electronic tickets of the plurality of target orders.

19. The reimbursement method according to claim 2, wherein upon determining that verification on the target order in terms of a plurality of target reimbursement categories succeeds, the following operations are performed:
using, based on a priority sequence of the target reimbursement categories, a reimbursement category with a highest priority in the plurality of matched target reimbursement categories as an expense control reimbursement category;
or
displaying the plurality of matched target reimbursement categories to the institution member, and using, as an expense control reimbursement category, a target reimbursement category selected by the institution member from the plurality of displayed target reimbursement categories;
or
determining an expense control reimbursement category from the plurality of matched target reimbursement categories based on historical reimbursement data of the institution member.

20. The reimbursement method according to claim 2, wherein upon determining that an execution result of the step of verifying whether element information recorded in the target order falls within a value range of an expense control element associated with the target reimbursement category is no, the following operations are performed:
determining a non-compliant element that is in the element information recorded in the target order and that is outside the value range of the expense control element associated with the target reimbursement category; and
generating expense control reminder information based on the non-compliant element and corresponding element information, and delivering the expense control reminder information to the institution member.

21. (canceled)

22. The reimbursement method according to claim 2, wherein the determining a target reimbursement category matching the target order in at least one reimbursement category of the expense control rule comprises:
detecting whether the target order matches a plurality of reimbursement categories of the expense control rule; and
upon determining that the target order matches a plurality of reimbursement categories of the expense control rule, using a reimbursement category with a highest priority in the plurality of matched reimbursement categories as the target reimbursement category based on a priority sequence of the reimbursement categories; or displaying the plurality of matched reimbursement categories to the institution member, and using, as the target reimbursement category, a reimbursement category selected by the institution member from the plurality of displayed reimbursement categories; or determining the target reimbursement category from the plurality of matched reimbursement categories based on historical reimbursement data of the institution member.

23. (canceled)

24. A computing device comprising a memory and a processor, wherein the memory stores executable instructions that, in response to execution by the processor, cause the processor to:
perform expense control verification on a target order of an institution member based on an expense control rule configured in a reimbursement code of an institution;
pay, upon determining that expense control verification succeeds, for the target order based on an institution account bound to the institution, to obtain bill information;
transfer the bill information to a ticket application link activated by an order participant, to generate an electronic ticket of the target order; and
create a reimbursement form of the institution member based on the electronic ticket and the bill information.

25. A non-transitory computer-readable storage medium comprising instructions stored therein that, when executed by a processor of a computing device, cause the processor to:
perform expense control verification on a target order of an institution member based on an expense control rule configured in a reimbursement code of an institution;
pay, upon determining that expense control verification succeeds, for the target order based on an institution account bound to the institution, to obtain bill information;
transfer the bill information to a ticket application link activated by an order participant, to generate an electronic ticket of the target order; and
create a reimbursement form of the institution member based on the electronic ticket and the bill information.
